(19) United States
(12) Patent Application Publication
(10) Pub. No.: US 2011/0004560 A1
(43) Pub. Date: Jan. 6, 2011

(54) SYSTEM AND METHOD FOR PROVIDING REAL ESTATE INFORMATION TO POTENTIAL BUYERS

(76) Inventors: MAX KNAKE, DALLAS, TX (US); JEFF PARTRIDGE, DALLAS, TX (US)

Correspondence Address: HOWISON & ARNOTT, L.L.P, P.O. BOX 741715, DALLAS, TX, 75374-1715, US

(21) Appl. No.: 12/830,722

(22) Filed: Jul. 6, 2010

Related U.S. Application Data
(60) Provisional application No. 61/223,185, filed on Jul. 6, 2009.

(51) Int. Cl. G06Q 50/00

(52) U.S. Cl. 705/313

(57) ABSTRACT

A system for providing real time property data to a potential real estate customer utilizes a property information server that provides real time property data to the potential real estate customer responsive to receipt of a unique identifier associated with a particular property. The property information server further maintains an email contact with respect to the potential real estate customer and notifies a subscriber of the interest in the particular property by the potential real estate customer.

### CROSS-REFERENCE TO RELATED APPLICATIONS

This application claims benefit of U.S. Provisional Application Ser. No. 61/223,185, filed Jul. 6, 2009, and entitled “EFASTINFO,” the specification of which is incorporated herein by reference.

### TECHNICAL FIELD

The present invention relates to managing and providing information with respect to real estate, and more particularly, to a manner for automatically providing property-specific information to potential buyers while enabling real estate brokers/agents to manage information with respect to potential buyers and specific properties.

### BACKGROUND

Prospective buyers of residential and commercial properties presently use a number of methods for obtaining information with respect to properties in which they may have an interest. Buyers may have information forwarded to them by their agent who is out looking for properties for them having particular characteristics. Additionally, buyers may contact potential sellers or brokers and agents of sellers responsive to ads within newspapers, signage placed upon properties that are being sold or leased or searching for information over the internet. However, all of these manners of obtaining information with respect to residential or commercial property that is being sold or leased have inherent delays, as the prospective buyer must wait for the real estate broker, agent, or seller to receive the email and provide responses thereto. Thus, prospective buyers have no means for requesting and receiving instant property, sales or lease information or images of the property in which they may have an interest without a manual process involving transmitting the information over the telephone or via email.

Presently, commercial and real estate agents/brokers respond to potential buyer inquiries in one of three ways. People interested in property listings call the agent or broker of the property to request property listing information. The agent or broker then must return the call or email information to the persons interested in a particular property.

In another method, people interested in a particular property listing have the ability to locate the listing information for the property online through either the agent/broker's website or another multiple listing service (MLS) website that contains listing information with respect to the particular properties. While this method enables a potential buyer to retrieve desired information, the process does not provide the agent or broker the ability to retrieve and store potential contact information with respect to the potential buyer.

Finally, with some properties, information may be available through short message service (SMS) transmissions. However, SMS messages are limited to 160 alphanumeric characters, provide no images and have a cost associated with each message. Additionally, this requires multiple user requests in order to receive all of the information that may be desired by a potential buyer.

Thus, prospective buyers have no means for requesting and receiving real time property sales and lease information with respect to a particular property. Additionally, residential and commercial real estate brokers and agents do not have the ability to provide this type of on-demand property information while having the ability to collect interested party contact information as the information is being requested by a particular party.

### SUMMARY

The present invention, as disclosed and described herein, in one aspect thereof, comprises a system for providing real time property data to a potential real estate customer. The system includes a property information server for providing the real time data to the potential real estate customer responsive to a unique identifier associated with the particular property. A database stores the real time property data. An email database stores email addresses associated with potential real estate customers. The property information server initiates the generation and transmission of an email including the real time property data to the potential real estate customer responsive to receipt of an email from the potential real estate customer including the unique identifier associated with the particular property. The property information server further stores the email address of the potential real estate customer that is indexed to the particular property associated with the unique identifier in the email database responsive to the receipt of the email from the potential real estate customer. The property information server further initiates the generation and transmission of an email to notify a subscriber of an interest in the particular property by the potential real estate customer responsive to receipt of the email.

### BRIEF DESCRIPTION OF THE DRAWINGS

For a more complete understanding, reference is now made to the following description taken in conjunction with the accompanying Drawings in which:

FIG. 1 illustrates the system wherein potential buyers may request information on a particular property via a property code;

FIG. 2 provides a functional block diagram of the property information application and the various functions provided via the property information application;

FIG. 3 is a flow diagram illustrating the manner in which a potential buyer may request and receive information relating to a particular property;

FIG. 4 is a flow diagram illustrating the manner in which a potential buyer may opt-out of receiving further information with respect to a particular property;

FIG. 5 is a flow diagram illustrating the manner in which property email alerts may be provided to potential buyers;

FIG. 6 is a functional diagram illustrating functions accessible via a property interface;

FIG. 7 is a flow diagram describing the manner in which a subscriber may register with the system;

FIG. 8 illustrates the subscriber registration interface;

FIG. 9 illustrates the my listings interface;

FIG. 10 illustrates the interface for entering a new property and associated data;

FIG. 11 is a functional diagram illustrating the various functions which may be performed from the manage contacts screen of the property information application;

FIG. 12 is a flow diagram describing the manner in which a subscriber may generate messages to select email contacts interested in a particular property;

FIG. 13 is the address interface illustrating all contacts interested in a particular property;

FIG. 14 is a flow diagram illustrating the manner for generating emails to potential buyers via the email contacts screen;

FIG. 15 is a functional diagram illustrating the manner in which particular contacts may be searched for via the contacts search screen;

FIG. 16 is a flow diagram describing the manner in which a contacts search may be generated via the contacts search screen;

FIG. 17 illustrates the search interface;

FIG. 18 illustrates the search results interface;

FIG. 19 is a flow diagram describing a first manner for updating information with respect to a particular property;

FIG. 20 illustrates an alternative embodiment for updating information with respect to a particular property;

FIG. 21 illustrates the reports generation interface;

FIG. 22 illustrates the reports listing interface;

FIG. 23 illustrates the generated reports interface;

FIG. 24 illustrates the address book interface;

FIG. 25 illustrates a particular contact interface;

FIG. 26 illustrates the alerts type interface;

FIG. 27 illustrates a price reduction alerts interface; and

FIG. 28 illustrates the open house alerts interface.

### DETAILED DESCRIPTION

Referring now to the drawings, wherein like reference numbers are used herein to designate like elements throughout, the various views and embodiments of a system and method for providing real estate information to potential buyers are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

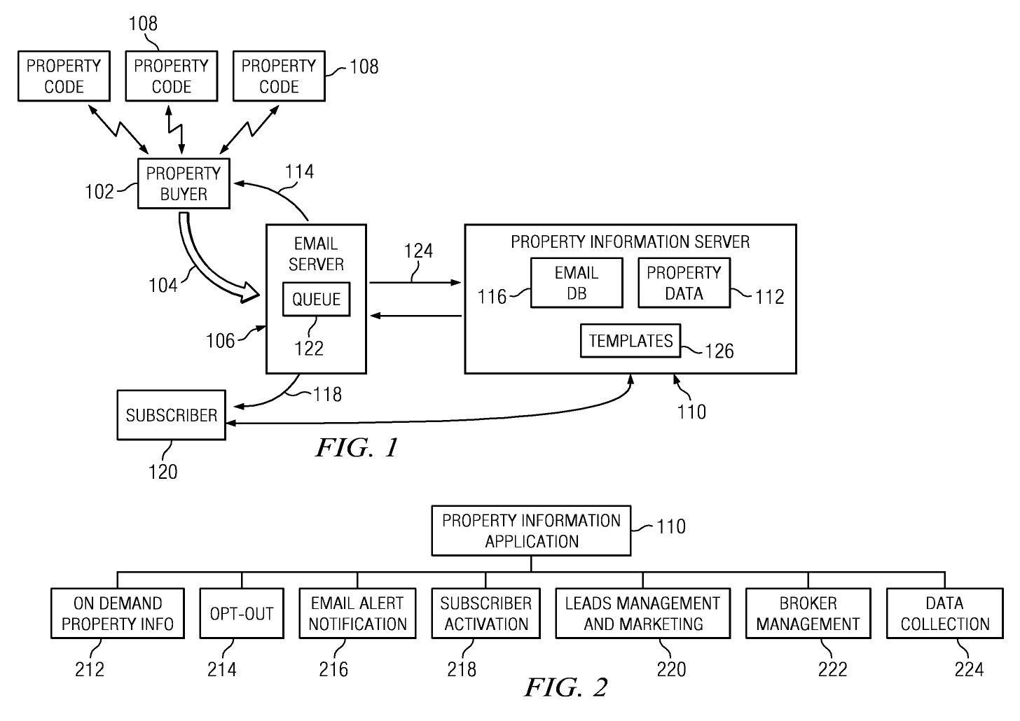

Referring now to the drawings, and more particularly to FIG. 1, there is illustrated a system providing potential buyers 102 with the ability to send an email 104 to a specified email address associated with an email server 106. The email 104 will include a request for information about a specific property. Each specific property has a unique contact code 108 that is associated therewith. Thus, by indexing the unique contact code with a database of properties, information about the particular property with which the potential buyer 102 is interested may be obtained.

The email server 106 is in communication with a property information server 110 that enables extraction of the data related to the contact code 108 from a property information database 112 that enables the email server 106 to send a response email 114 back to the property buyer 102 with information about the property associated with the property code 108. The response email 114 to the property buyer 102 includes detailed property information, property images, property documents, and agent/broker information.

In addition to providing information to the property buyer 102, the system enables the creation of an email database 116 within the property information server 110 of potential buyers 102 that are indexed with a particular property or properties. This email information may be accessed by a subscriber 118 via the property information server 110. The email server 106 additionally sends an email 118 to a subscriber 120 to provide the email address of the newly interested potential buyer 102. Thus, the system is able to assist subscriber 120 in collecting the email address of potential buyers 102 within the email database 116 and have this email address associated with the attributes of a particular piece of residential or commercial property.

Referring now to FIG. 2, there is illustrated a functional block diagram of the property information application server 110. The property information application server 110 includes a number of functionalities for internal applications therein that enable the communication and management of real time property information to potential buyers and to enable subscribers (real estate brokers/agents) to maintain the database of potential contacts. These include on-demand property information provision 212, opt-out application 214, email alert notification 216, subscriber activation 218, leads management marketing 220, broker management 222 and data collection 224.

The on-demand property information provision application 212 enables a potential buyer 102 to be provided information with respect to a particular property responsive to a provided unique contact code 108. The opt-out application 214 is utilized to encourage more prospective buyers to utilize the property information application process. Prospective buyers will be more likely to utilize the system if they have the ability to opt-out of receiving further marketing information from the real estate broker/agent associated with the properties with which they are initially requesting information. Thus, the potential property buyer 102 is not locked in to receiving an undesired stream of emails relating to the property or other properties that the broker/agent has within their listing portfolio. Thus, the opt-out application 214 provides the ability to opt-out of receiving further marketing messages. This is achieved by sending an email to a selected email address such as stop@domain.com. Within the email that is sent to the opt-out email address, the contact code 108 that is uniquely associated with the property is included within the subject line of the email. The opt-out application 214 stops all further emails to the potential buyer 102 from the marketing subscriber 120 for the specific property associated with the contact code 108. This option is included within every email sent by the property information server 110 to the potential buyer 102 such that they have the ability to opt-out of the process at any point in time.

The email alert notification application 216 enables a potential buyer 102 to be periodically updated with information regarding the property in which they have previously expressed an interest through the application. Real estate prices are subject to various market conditions and are constantly changing. Thus, potential buyers are required to continuously search in order to understand and maintain information with respect to property listing information that has changed on properties in which they are interested. The email alert notification application 216 provides the ability to send out an automated email from the property information server 110 based upon changes in the data associated with a particular property with which the potential buyer 102 has expressed previous interest.

Once a potential buyer 102 has made an inquiry on a particular property, the email alert notification application 216 transmits an automated email alert responsive to a number of changing variables including, but not limited to price changes, showing/open houses, vacancies, sales, purchase/lease status (active, pending, sold, active), and new listings which have similar characteristics to the property in which the potential buyer 102 has previously expressed an interest. The email alert notification application 216 enables a potential buyer 102 to receive information for what is going on in the real estate markets in an automated format. The events which may trigger an alert include a price change of the property wherein the sale or lease price associated with the property changes; an open house or showing date being assigned for a property of interest within the current week; or a property that has been previously inquired about having new vacancies come available therein. An alert is sent if a previously inquired upon property has a sales status change such as active, pending, option, cancelled, contingency contract, withdrawn. Additionally, alerts may be generated if new listings within an associated geography, price or size related to the previously inquired property become available. The email alert notification application 216 sends the alert to the potential buyer 102 and includes the property address along with the property data variables that have changed.

The subscriber activation application 218 enables a real estate broker or real estate agent, the “subscriber,” to register all of their listing properties with the property information server 110 such that potential buyers 102 may begin accessing the properties via unique contact codes 108. The subscriber activation application 218 enables a potential subscriber to enter a variety of information with respect to the subscriber. This can include information such as MLS subscriber ID, first name, last name, email address, password, uploaded logo, uploaded headshot, company street address, company city, company state, company zip code, brokerage name, contact phone number, company website, whether the agent is licensed, the number of contact codes that are needed and a description of the services provided by the subscriber. This information is used by the subscriber activation administration application 218 to determine whether or not the subscriber should be accepted. If so, the subscriber is accepted and various unique contact codes are provided to the subscriber, and the subscriber may associate the contact codes with their properties.

The leads management and marketing application 220 enables a subscriber to manage their email contacts and properties within the property information server 110. Once an email of a potential buyer 102 has been stored within the email database 116, the subscriber 120 has the ability to access these email addresses in a number of fashions. The subscriber may access the email address through the address of the property in which the potential buyer 102 has expressed an interest. Alternatively, the subscriber may access the email address through a listing of the user email addresses. The subscriber 120 may also search for user email addresses via a property address search which enables the listing of potential buyers 102 by the types of properties in which they have expressed an interest.

The broker management application 222 enables the broker/agent to control the access to the account associated with a broker/agent. In one implementation, the broker/agent can temporarily share an account with another subscriber. This function enables a subscriber to give temporary access to other subscribers to view their property listings, contacts and respond to contacts during a selected duration of time. Additionally, the subscriber can create sub agents for one or more of their property listings. A sub agent has access to all of the property listing functions associated with a particular property. Through the broker management application 222, the subscriber can also view all of the contact information metrics associated with all subscribers and their property listings with respect to a particular broker.

The data collection application 224 controls the manner in which data is collected and updated with respect to the properties having information stored within the property database 112 of the property information server 110. The property data must be continuously or periodically updated such that when a potential buyer 102 requests information about a particular property, the potential buyer 102 is provided with the most up-to-date available information on the property. The data collection process application 22 may collect data in a number of fashions as will be more fully described hereinbelow.

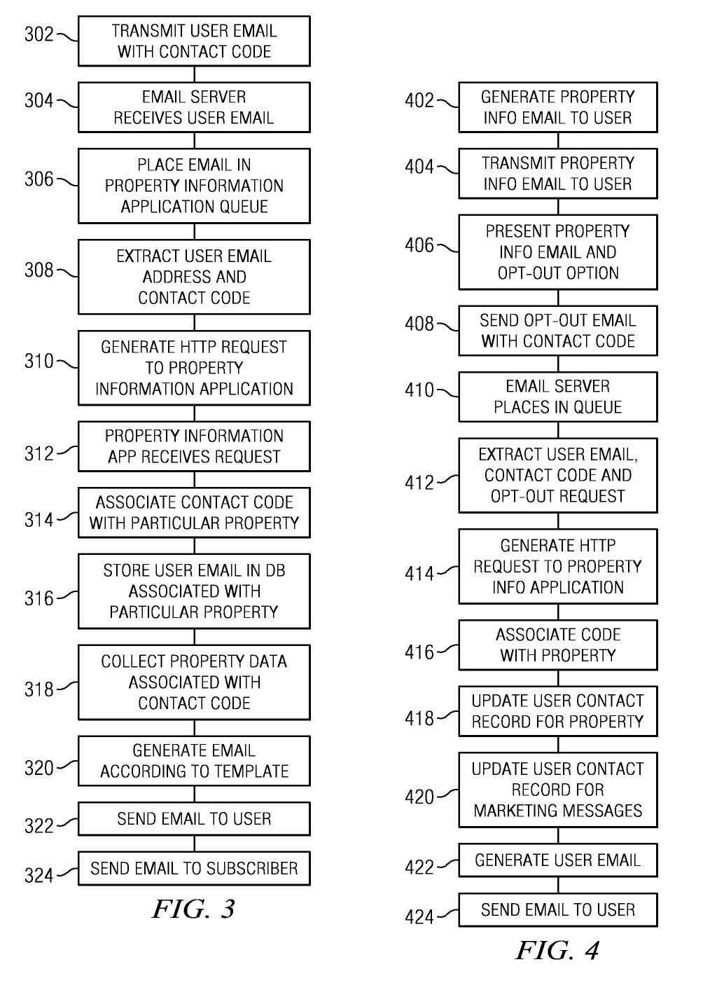

FIG. 3 is a flow diagram illustrating the process by which the on-demand property information application 212 provides property information to a potential buyer 102 responsive to an email request 104. Initially, at step 302, the potential buyer 102 generates and transmits the email 104 to the email server 106 at an email address, for example, info@domain.com. The email 104 includes within its subject line a unique alphanumeric contact code. The email 104 may be transmitted from any email client enabled device such as a cell phone, PDA, laptop computer, etc. The email server 106 receives at step 304 the user email from the potential buyer 102. The email server 106 places the email 104 received from the potential buyer 102 within a queue 122 within the email server 106 at step 306. The email server 106 extracts at step 308 from the received email 104 the email address associated with the potential buyer 102 and the unique alphanumeric contact code within the subject line. The email server 106 generates an HTTP request to the property information server at step 310. The HTTP request 124 includes the extracted user email address and unique contact code. At step 312, the generated HTTP request is received by the property information server 110. The property information server 110 associates at step 314 the contact code within the HTTP address with the particular property uniquely associated with the contact code. The contact code is indexed with the property within the property database 112. The property information server 110 also stores at step 316 the received user email in the email database 116. The email address is associated with the particular property on which the user has requested information.

Property data associated with the property identified by the contact code is collected at step 318. The property data is stored within the property database 112 and includes information such as property type, property listing information (number of bedrooms, number of bathrooms, school district, subdivision, etc.), property images, property documentation and subscriber marketing information. Using the collected property information from the property database 112, an email is generated at step 320 according to a pre-established template. The template would be retrieved from a template database 126 within the server 110. The selected email template is based upon the property type on which the inquiry is based, i.e., residential, commercial, multi-family, etc. The formats of the emails will be different depending upon whether it is an email concerning a residential property, commercial property, multi-family property or other type of real estate property. The generated email is transmitted to the potential buyer 102 through the email server 106. Thus, the formatted email is transmitted from the property information server 110 to the email server 106, and the email server 106 transmits the email to the property buyer 102 at step 322. The email transmitted to the user at step 322 is accomplished through POP/IMAP. Finally, at step 224, the property information server also generates a notification email to the subscriber 120. This email is provided from the property information server to the email server 106 and to the subscriber 120. The notification email notifies subscriber of the particular property listing that has been inquired about and the user's email address associated with the property inquiry using POP/IMAP messaging. The email is also generated from a template in the template database 126.

FIG. 4 illustrates a flow diagram describing the manner in which a potential buyer 102 may opt-out of the property information provision system. The opt-out application 214 provides the functionalities described with respect to the flowchart of FIG. 4. The user is initially provided a property information email at step 402 in the manner discussed previously with respect to FIG. 3. This generated property information is transmitted to the user via an email at step 404. Within the email, the user is presented with an opt-out option at step 406. This opt-out option provides an indication to the potential property buyer 102 that they may opt-out of receiving further emails about the inquired property by sending an email to a predetermined email address such as stop@domain.com and by including the contact code within the subject line of the opt-out email response. The opt-out email including the contact code is transmitted to the email server 106 at step 408.

The received email is placed within the queue 122 within the email server 106 at step 410. The user email and contact codes are extracted at step 412 from the opt-out request and this information is used to generate at step 414 an HTTP request to the property information server 110. When received at the property information server 110, the contact code is used to associate the HTTP request with a particular property at step 416. The user contact record associated with the property identified by the contact code is updated at step 418 such that the user will no longer receive information with respect to that property. Additionally, the user contact record is updated with respect to marketing messages at step 420 to discontinue the user from receiving marketing messages.

The property information server 110 generates a formatted email using a template from the template database 126 to notify the user that they will no longer be receiving emails at step 422. The generated email is transmitted to the user at step 424 from the property information server through the email server 106 using POP/IMAP messaging.

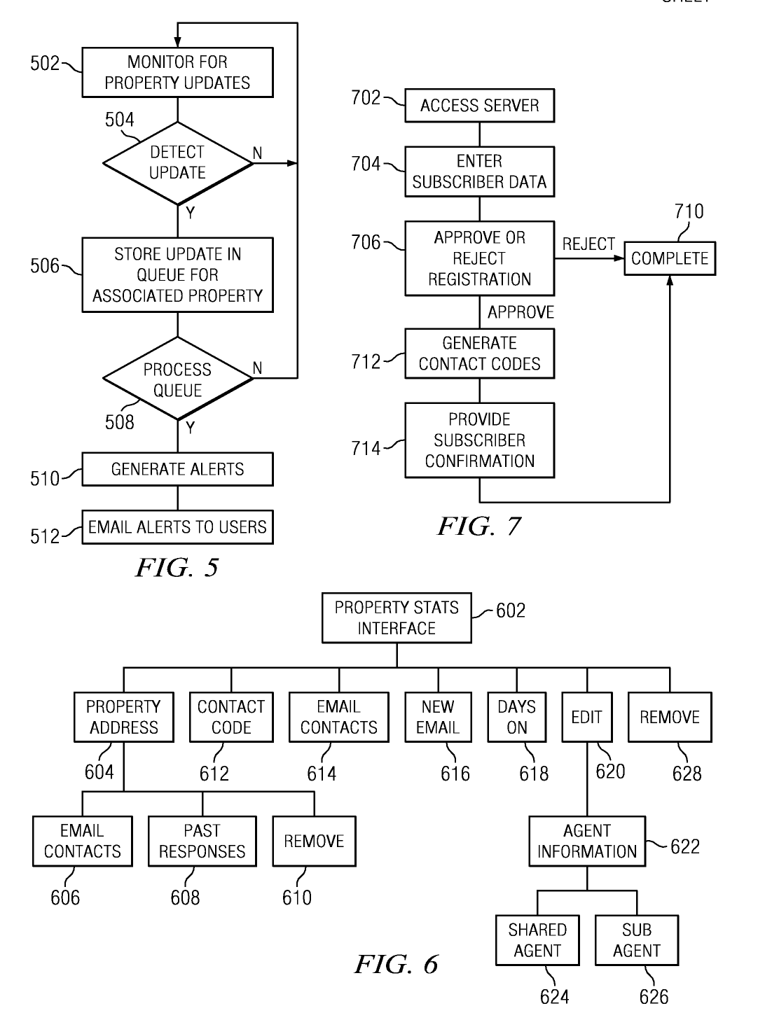

Referring now to FIG. 5, there is illustrated a flow diagram describing the operation of the email alert notification applications 216. As described previously, the email alert notification application 216 provides alerts to a potential buyer 102 responsive to changes in information with respect to a property that a potential buyer 102 has previously expressed an interest. The property information server 126 monitors for property updates with respect to the data associated with property stored within its property database 112 at step 502. Inquiry step 504 determines whether an update has been detected for a property associated with the property database 112. If not, control passes back to step 502 and the server 110 continues monitoring for property updates. When inquiry step 504 determines that data for a particular property has been updated, the update is stored within a queue for the associated property at step 506. As described previously, the type of updates which will trigger the storage of an update within the queue associated with the property include the updated information such as a price change with respect to the sale or lease price of a piece of property, an indication that an open house or showing date is available for the property, an indication that the property of interest has new vacancies with respect thereto, or there has been a change in status of the property sale or lease. Additionally, alerts can be generated responsive to a new listing having characteristics similar to those of a previously inquired on piece of property.

Inquiry step 508 determines if the email alert notification application 216 needs to perform one of its periodic processings of the queued information. If not, control passes back to step 502 and the server monitors for additional property updates. Once inquiry step 508 determines that it is time to process the update queue, the email alert notification application 216 processes the queue and generates various alert messages at step 510 to potential buyers 102 that have made inquiries about properties associated with the alerts without opting out. The alerts are emailed to the designated users at step 512. The generated emails are based upon templates contained with the template database 126. The email alerts that are generated at step 510 may be of different types depending upon the data that has been changed with respect to the property. These can include a price reduction email alert email, a home open house alert email, a property status change alert email or a new listing alert email. The email alerts are transmitted to the users at step 512 using POP/IMAP messaging.

Referring now to FIG. 6, there is illustrated a functional block diagram of the property listing interface 602 and the various functionalities associated therewith. The property listing interface 602 enables a subscriber (real estate agent/broker) to access the various information related to their properties, send emails to potential contacts and update and receive statistics with respect to the property. Property address functionality 604 provides the subscriber (real estate agent/broker) with information with respect to the email contacts that are associated with a selected property. Information that may be accessed via the property address functionality 604 includes the email contacts 606 that have inquired about the particular property associated with the property address. The subscriber may also access past responses 608 that have been received with respect to the property. The past responses 608 may include emails or requests for information sent by the users associated with the email contacts 606 with respect to the property at the property address. A remove function 610 enables a subscriber to remove email contacts 606 from the property address functionality 604. This will be used when a user associated with an email contact 606 has ceased expressing an interest in a particular property.

The contact code functionality 612 enables the subscriber to assign a contact code to a particular property that the real estate agent/broker is presently managing. By assigning the contact code via the contact code functionality 612, outside users may email the contact code to the email server 106 as described previously in order to initiate receipt of information about the property from the property information server 110.

The email contact functionality 614 enables the subscriber to access and search their email contacts directly without utilizing the property address functionality 604. The email contacts functionality 614 lists all of the email contacts with respect to all of the properties that the subscriber is managing. The subscriber is able to select and transmit information to the various email contacts listed within the email contact functionality 614. The new email functionality 616 allows the subscriber to create and generate emails to various email contacts relating to the properties or other matters relating to the management of the properties listed within their system.

The days on market functionality 618 provides a listing of the number of days that a particular property associated at a particular property address has been on the market. This information is important to the subscriber and provides indications of when price adjustments or other matters need to be addressed with respect to a particular property. The edit functionality 620 enables the subscriber to alter information with respect to a particular property or the email contacts associated therewith.

Within the edit functionality 620, the agent information function 622 enables the subscriber to control who has access to their particular properties under the property statistics interface 602. Under the shared agent functionality 624, the subscriber has the capability to provide access to other subscribers to view property listings, contacts and respond to contacts during a selected period of time. Through the subscriber's edit page functionality 620, the subscriber may select another subscriber from a dropdown menu and assign them as their replacement to receive all emails and have access to their property listings. This functionality will add the subscriber's properties to the shared subscriber's properties when they log in to the system.

Through the sub agent functionality 626, the subscriber can create sub agents for one or more of their property listings, which will provide access to all of the property listing functionalities with the sub agent. This enables more than one subscriber to be associated with a property listing. The primary subscriber can assign up to a selected number of sub agents for a particular property listing. The sub agents will have the ability to access the property listing's contacts statistics on the property stats interface 602. The remove function 628 enables a subscriber to remove a particular property from the property address list 604 when they are no longer part of the subscriber's portfolio.

A broker management function 630 may also be included to allow the broker subscriber to view all of the contact performance metrics associated with each subscriber (real estate agent) that they are managing and the property listings that are within the broker's management responsibility.

Referring now to FIG. 7, there is illustrated a flow diagram describing the process by which a subscriber may register with the property information server 110 to enable them to utilize the services described herein. The process is initiated at step 702 when the subscriber accesses the property information server 110. During the registration process to the property information server 110, the subscriber enters various subscriber data at step 704. The subscriber data includes a number of information items including, but not limited to the MLS subscriber ID, first and last name, email address, password, company logo, company address, brokerage name, contact phone number, company website, subscriber license, and a description of the subscriber services. Additionally, the subscriber provides the number of contact codes that are desired by the subscriber. These are the contact codes that are associated with each of their properties enabling a user to automatically receive information with respect to the property. The subscriber may additional enter credit card or some other type of payment information to pay for the subscription to the service.

The property information server 110 will either approve or reject the registration of the subscriber at step 706. If the registration is rejected, the process is completed at step 710 and no further access by the subscriber is enabled. If inquiry step 706 approves the registration of the subscriber, the requested number of contact codes are generated at step 712 by the property information server. As discussed previously, the contact codes are the unique four alphanumeric characters that enable access to the properties. Other numbers of characters or types of characters may also be utilized. The generated contact codes are provided at step 714 to the subscriber along with a registration confirmation email. The process is completed at step 710 and the subscriber has the ability to log in to the property information server and assign their confirmation codes to their associated properties.

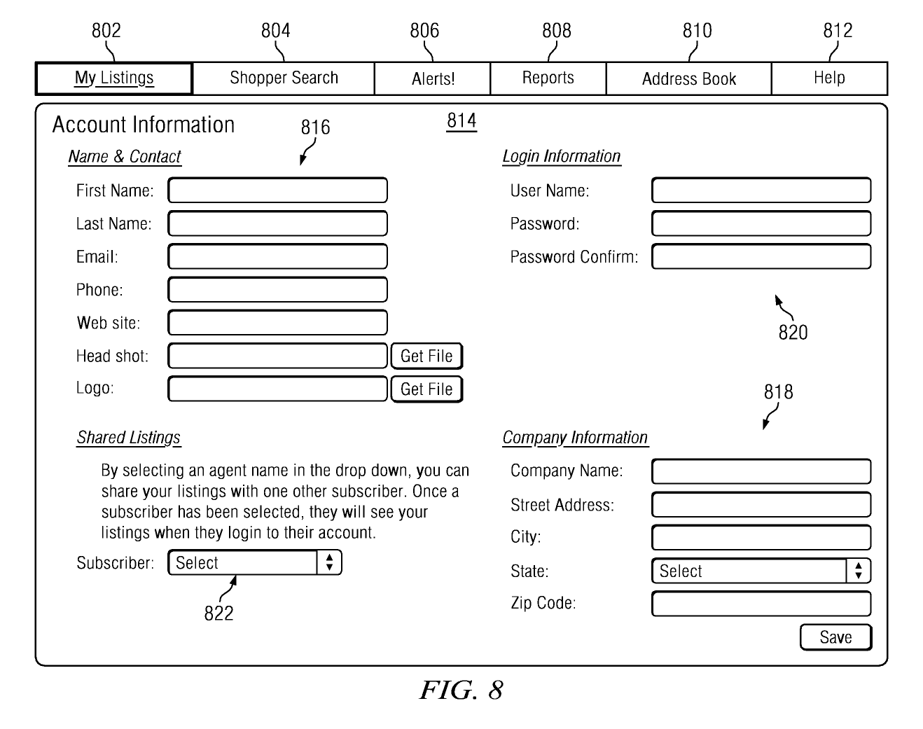

Referring now to FIG. 8, there is illustrated the subscriber interface wherein the subscriber may register with the property information server 110. Included along the top of the interface are a number of function buttons including the my listings button 802, a shopper search button 804, an alert button 806, a report button 808, an address book button 810 and a help button 812. The my listings button 802 enables the subscriber to have access to all of the properties with which they have associated a contact code or to register with the system. The shopper search button 804 enables the subscriber to search for particular types of property about which they may wish to contact a member of their contact list. The alert button 806 enables the subscriber to view the alert messages that have been sent to potential buyers 102. The report button 808 enables the generation of reports related to properties by the subscriber. The address button 810 enables the user to access an address book of all available contacts and the help button 812 enables the accessing of help functions.

The account information screen 814 enables the user to enter the subscriber registration information discussed previously with respect to FIG. 7. The name and contact information fields 816 enables the entry of the information with respect to the name, email, phone, website, headshot and logo of the subscriber. Similarly, the company information field 818 enables entry of information with respect to the company that the subscriber works for. The log in information field 820 enables the subscriber to enter the log in information enabling the subscriber to access their listing information. These include the user name and password. Finally, the shared listing subscriber menu 822 enables the subscriber to select a secondary subscriber who may have access to the listings of the primary subscriber.

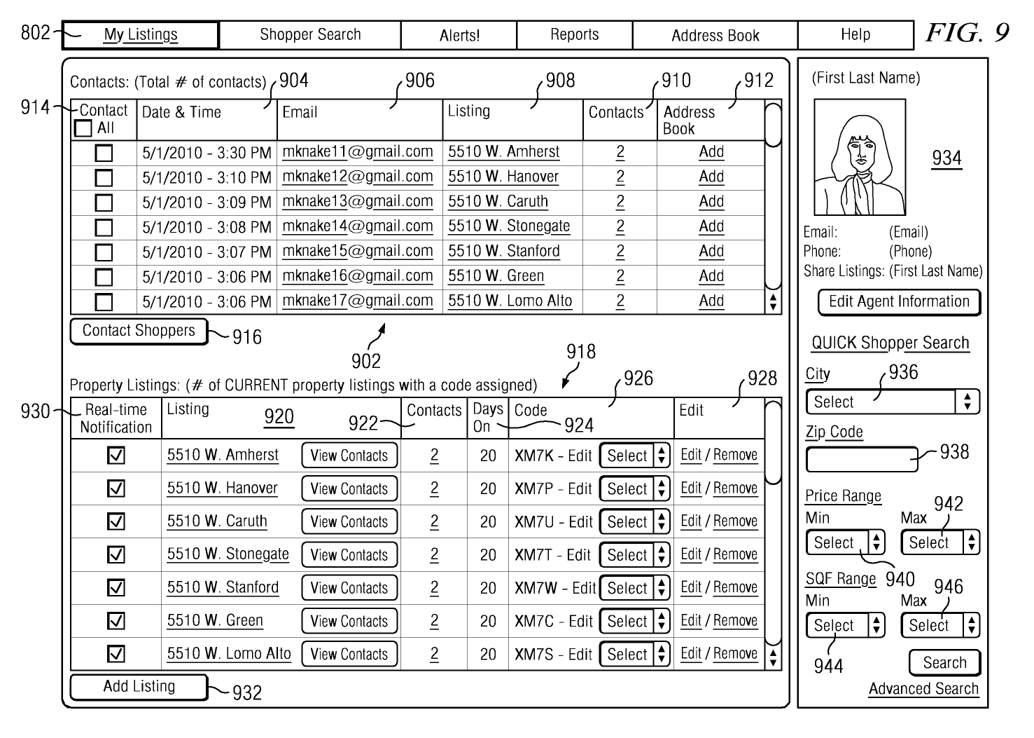

Referring now to FIG. 9, the my listings button 802 enables the subscriber to view various types of information with respect to their properties. The contacts window 902 provides a listing of all of the contacts available to the subscriber. The contacts window 902 includes a date and time field 904 indicating the time that the contact first was achieved, an email field 906 to list the contacts email address, a listing field 908 to indicate the listing with which the contact is associated, a contacts field 910 indicating the number of times the email address has been contacted and the address field 900 indicating whether the contact should be added to the subscriber's address book. A contact button 914 allows the subscriber to select particular ones or all of the associated contacts for the sending of email information. The contact shoppers button 916 enables an email to be generated and sent to the marked contacts in the contacts field 914.

The property listings field 918 provides a listing of all of the properties associated with the subscriber. The listings column 920 includes the listing properties of the subscriber. The contacts field 922 indicates the number of contacts with respect to that property. The days on market field 924 indicates the number of days that the property has been on the market and the code field 926 indicates the contact code associated with the property. The edit fields 928 enable the subscriber to either change or remove information with respect to the listings. Real time notification with respect to the listing 902 may be achieved by checking a box within a real time notification field 930. The add listing button 932 enables a subscriber to add additional listings with a newly received contact code as new properties become available. Search window 935 enables the display of information with respect to the particular agent and includes general search fields for searching contacts with respect to current and past listings. These include a city menu 936 for selecting a city for a search, a zip code field 938 for selecting zip codes, a min and max price range fields 940 and 942 and a min and max square footage range search field 944 and 946.

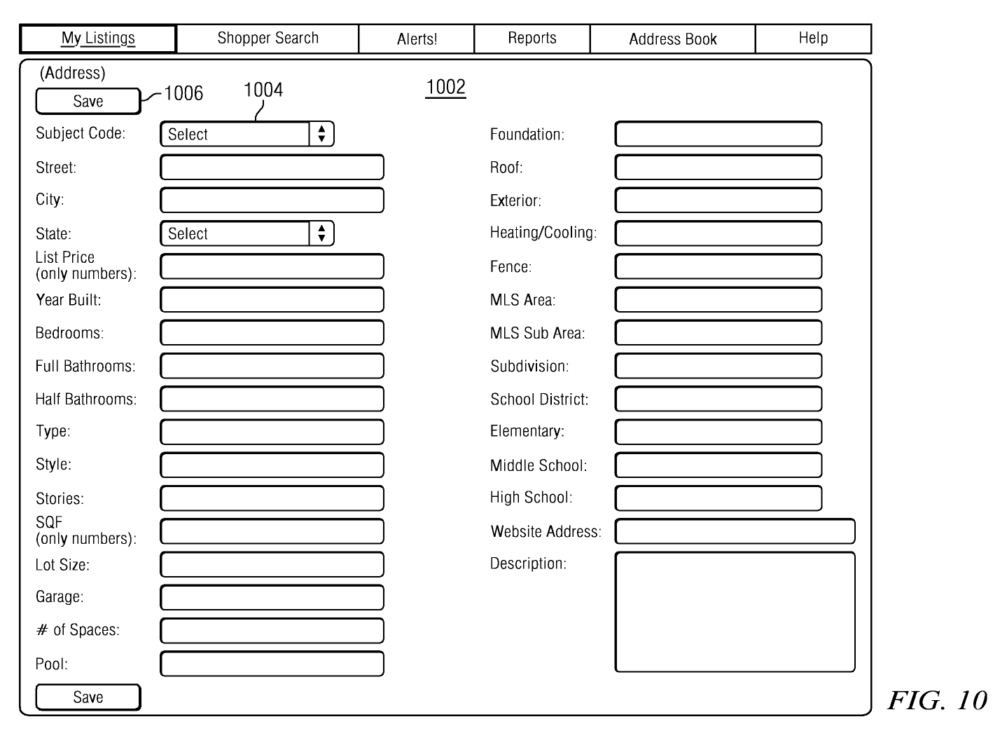

When the subscriber selects the add listing button 932, this causes the interface illustrated in FIG. 10 to be displayed. This new listings window 1002 includes a number of fields listing information about the property. The subject code field 1004 enables the subscriber to select the contact code which is to be associated with this property. The remaining fields include various property parameters that are commonly associated with the sale of real estate property. Once all of this information has been entered into the related fields, the listing is saved by clicking on a save button 1006.

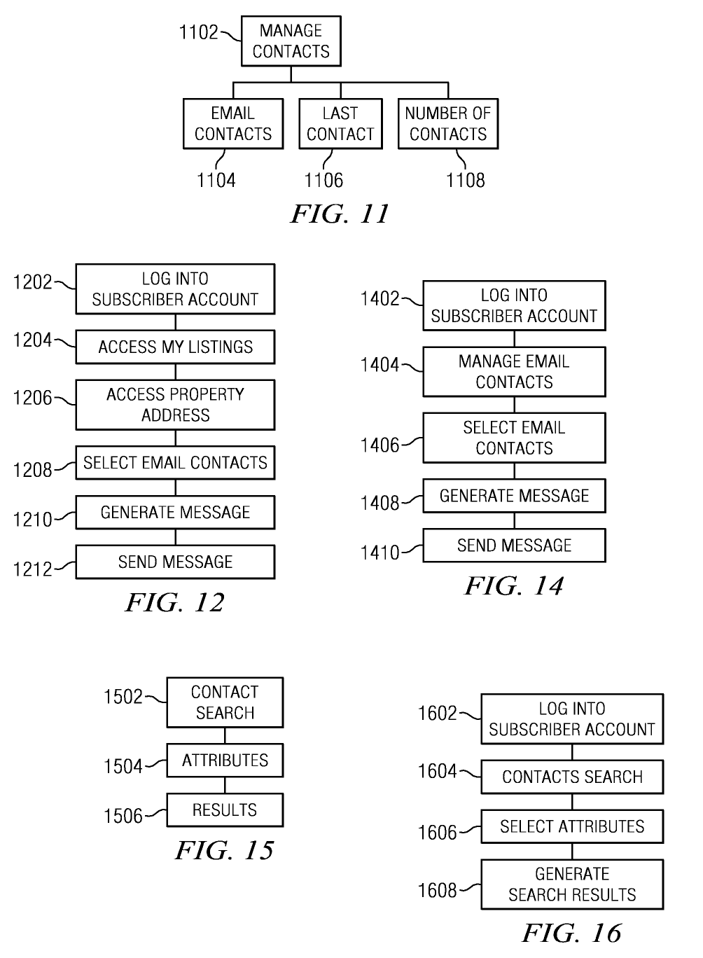

Once a subscriber has registered with the property information server 110, they have the ability to access and manage their contacts and manage and market their properties associated with the assigned contact codes. FIG. 11 illustrates the manage contacts interface function 1102 provided via the property information server 110. Through the manage contacts functionality 1102, the user may manage their email contact functionalities 1104 enables the user to manage their email contacts. The last contact functionality 1106 provides information to the subscriber with respect to the last email contact that has been received with respect to a particular property. The number of contacts functionality 1108 provides a listing of the number of contacts that are associated with a particular property.

Referring now to FIG. 12, there is illustrated one manner in which the subscriber may manage their properties utilizing the property information server 110. The subscriber logs in to their subscriber account on the property information server 110 at step 1202. The user accesses their subscriber listings via the subscriber listing functionality at step 1204. From the subscriber listings, the subscriber may access a particular property address at step 1206. Once the property address is displayed, each of the email contacts associated with the property are also displayed and the subscriber selects a particular email contact at step 1208. Once a particular email contact has been selected, the subscriber generates messages with respect to this email contact at step 1210. The generated email message is sent to the contact interested in the property at step 1212. In this manner, the subscriber to user emails are generated by drilling into the particular property that the subscriber is responsible for and allows them to manage and send information to contacts on a property specific basis.

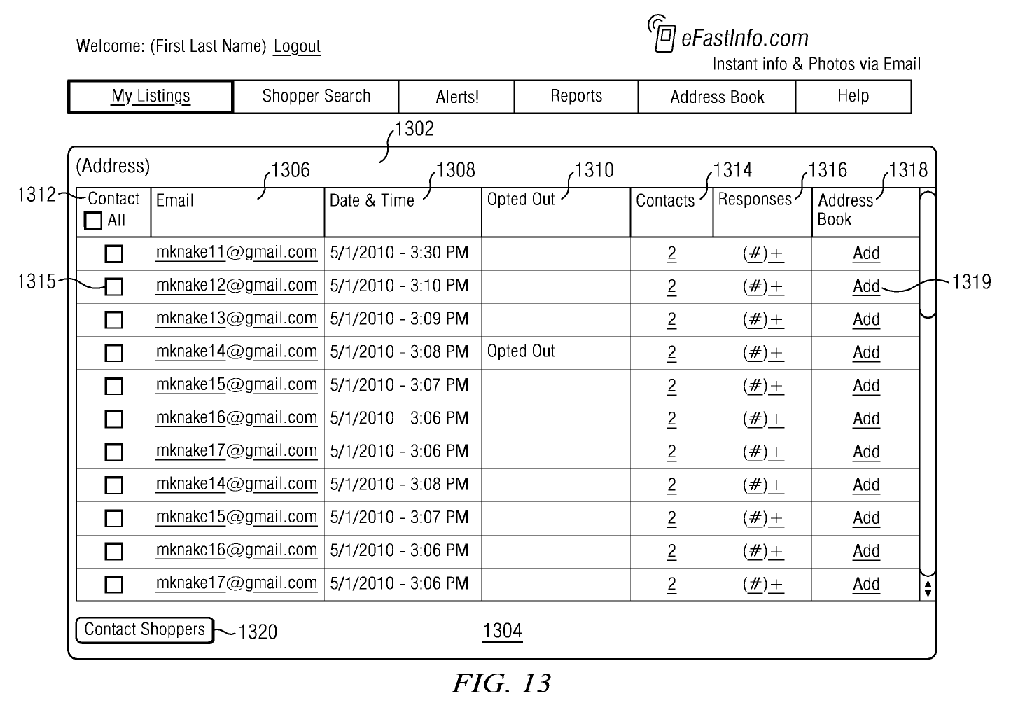

Referring now to FIG. 13, there is illustrated an interface wherein the contact information described with respect to FIG. 12 is displayed via the subscriber's interface. Information field 1302 illustrates the contact statistics with respect to a particular address in Dallas, Tex. The information block 1304 includes information on each of the potential email contacts that have contacted the subscriber with respect to the property listed in information field 1302. The information block includes an email column 1306 listing the email contact for a potential buyer. Column 1308 indicates the last time and date that the potential buyer has contacted the subscriber. Field 1310 indicated whether the potential contact has opted out or may still be contacted by the subscriber. Field 1312 includes a number of boxes 1315 which may be selected in order to generate emails to the associated email contact. Field 1314 lists the number of contacts that have previously been made with respect to the email address and by clicking on the contact 1317, the various contacts may then be viewed. Field 1316 illustrates the number of responses that have been received from the potential buyer associated with the email address. Using the add links 1319 in column 1318, the email contacts may be added to the address book. Finally, button interface 1320 is used to send an email to each of the contacts that have been selected via the boxes 1315 in the contact column 1312.

Referring now to FIG. 14, there is illustrated a flow diagram describing the manner in which a user may access their email contacts by accessing via the user email address in the contacts window 902. The subscriber logs in to their subscriber account at step 1402 and selects the manage email accounts link at step 1404. The user selects various email contacts at step 1406 that they wish to contact. The user generates a message at step 1408 to the selected email contacts by selecting the contact shoppers button 916 and transmits the message to the selected shoppers after generation of the message at step 1410.

Referring now to FIG. 15, there is illustrated a functional block diagram of the manner in which contacts may be searched for using the search functionalities associated with the shopper search button 804. By actuating the contact search functionalities 1502 through the shopper search button 804, the subscriber selects a number of property attributes 1504 that they wish to search for within the available properties. Responsive to these selected attributes, search results 1506 are provided from the available properties.

Referring now to FIG. 16, there is illustrated a flow diagram describing the manner in which the search process operates. The subscriber logs in to their subscriber account at step 1602. The subscriber accesses the search functionalities by initiating the contacts search function at step 1604 via the shopper search button 804. The various attributes on which the subscriber wishes to search are entered in at step 1606 and these selected attributes are used to generate the search results at step 1608 by searching the property database 112.

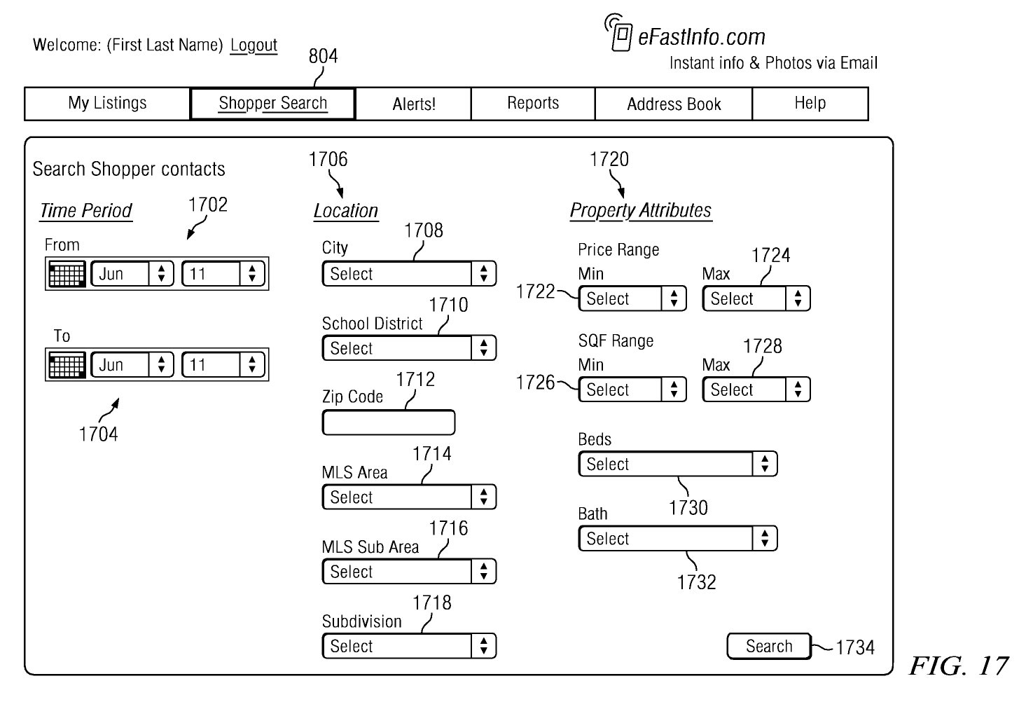

Referring now to FIG. 17, there is illustrated the subscriber search interface associated with the shopper search button 804. The search interface includes time periods fields 1702 that enable a subscriber to search for contacts that have been received within a particular time period. These include the “from” time period 1702 and the “to” time period 1704. The locations fields 1706 enable a subscriber to select a number of location-specific parameters including the city 1708, school district 1710, zip codes 1712, MLS area 1714, MLS sub area 1716, and sub division 1718. Additionally, the property attributes field 1720 enables the selection of a number of parameters associated with the property. These include min and max price ranges 1722 and 1724, min and max square footage ranges 1726 and 1728, number of bedrooms 1730 and number of bathrooms 1732. The search for properties having these attributes is initiated by clicking on the search button 1734.

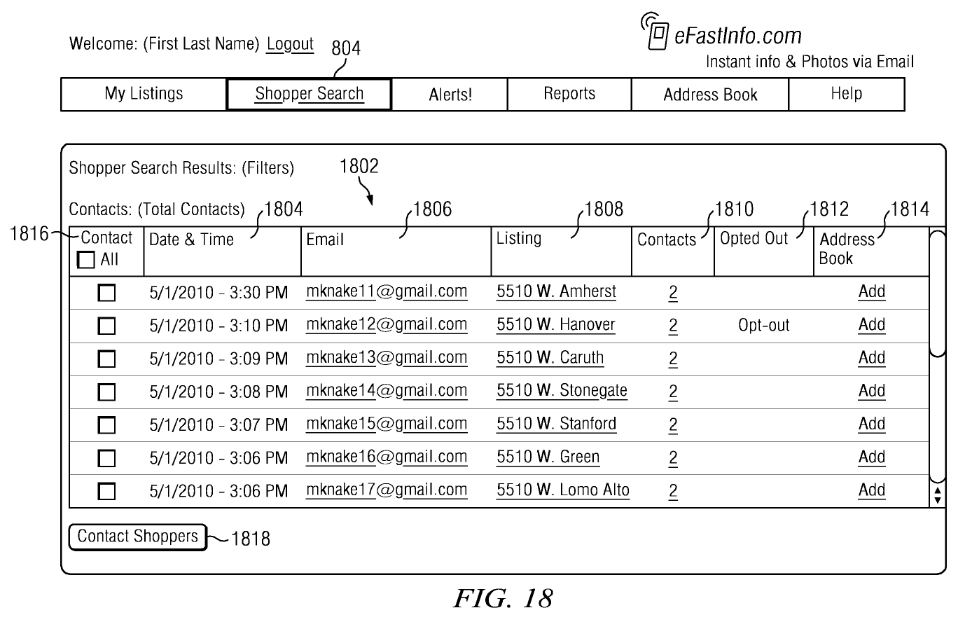

Once the search has been generated, a results interface is provided as shown in FIG. 18. The results window 1802 includes date and time fields indicating when the contact was originally generated, an email field 1806 indicating the email of the contact, a listing field 1808 indicating the address on which the contact originally requested information. A contact field 1810 indicates the number of contacts that have been generated to the contact. An opt-out field 1812 indicates whether the contact has opted out of receiving further information, and an address book field 1814 enables the contact to be added to the subscriber's address book. The contacts field 1816 enables the subscriber to select particular contacts to which they desire to generate an email contact and this is initiated by the contact shoppers button 1818.

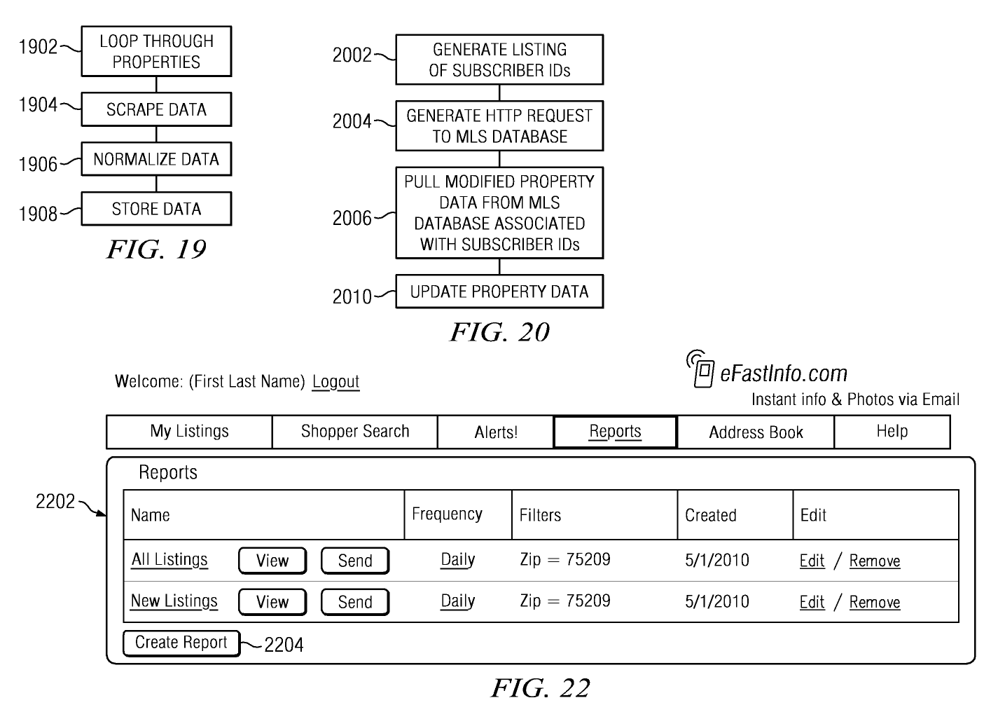

There are a number of ways in which the data associated with each of a subscriber's listed properties may be periodically updated or collected by the property information server 110. FIG. 19 illustrates a screen scrape process using the selling broker's website. In this process, the property information server 110 periodically loops through all of the properties listed on a broker's website. The property information server 110 scrapes the property listings and subscribing data from these properties at step 1904. The scraped data is normalized at step 1906 to be stored within the property database 112 of the property information server 110. This normalized data is stored within the property information database 112 to be accessed by the subscriber.

Additional means of updating the database may involve pulling all of the agent and property listing data from an FTP server location. The property information server 110 would download a .csv file nightly and update the property listing data within the database 112 with removed property listings, new property listings and changes to existing property listings data deemed revised at this time. Additionally, the system could be directly integrated into the broker's database and the information operating within the broker's database would pull the necessary data.

Finally, as illustrated in FIG. 20, the property information server 110 is integrated with an MLS listing interface such that property listing data and images is updated incrementally, for example, every two hours. The process involves the generation of a listing of all subscriber IDs at step 2002. This includes all of the subscribers that are associated with a particular broker or brokers. The property information server 110 generates an HTTP request to the MLS database at step 2004 requesting all property data associated with the subscriber IDs generated at step 2002. The modified property data associated with each of these IDs is pulled from the MLS database at step 2006. This information is downloaded to the property information server at step 2010 and used to update the database 112 at step 2020.

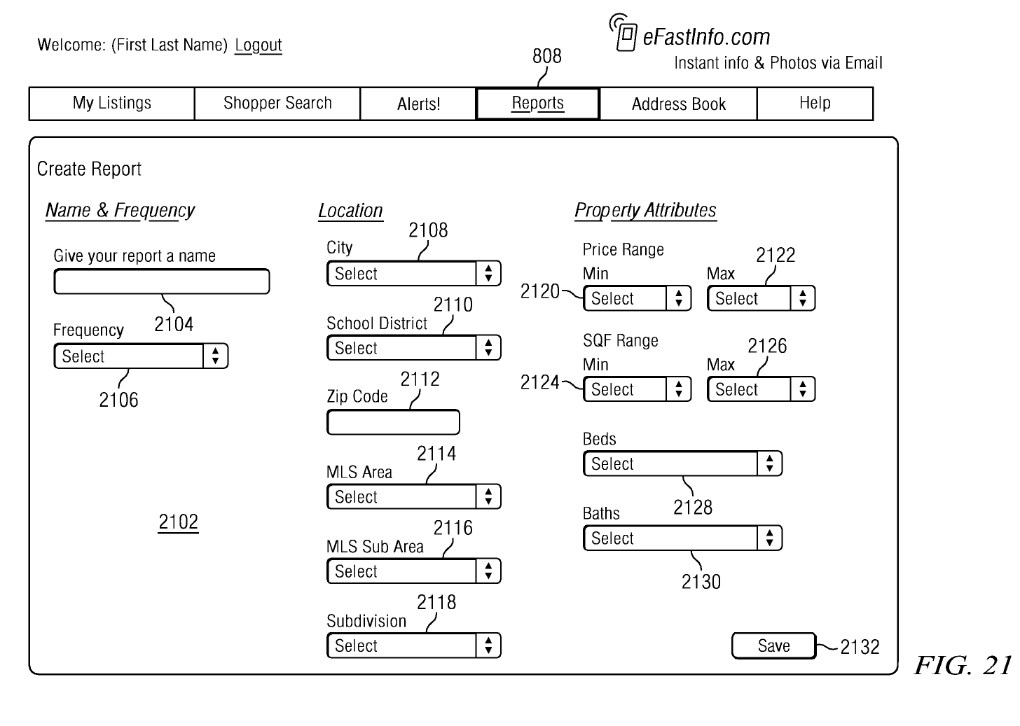

Referring now to FIG. 21, there is illustrated the interface that is provided responsive to selection of the reports button 808. The report interface 2102 includes a number of fields enabling a subscriber to periodically have reports generated about their associated properties. A name field 2104 enables the user to select a name for their report. The frequency dropdown menu 2106 enables the subscriber to select the frequency with which this report is to be created. Location fields enable the subscriber to select the areas on which the reports are to be generated. These fields include a city menu 2108, school district menu 2110, zip code field 2112, MLS area menu 2114, MLS sub area menu 2116 and sub division 2118. The subscriber may also select a number of property attributes including price min and max fields 2120 and 2122, square footage range min and max fields 2124 and 2126, the number of bedrooms in the house 2128 and the number of bathrooms in the property 2130. After all of this information is prepared, the report is saved by clicking on a save button 2132.

After the report is saved, all saved reports may be viewed via reports interface 2202 illustrated in FIG. 22. The reports field 2202 includes the name of the reports, frequency of the reports and the various filters that may be applied to the reports. The reports may be generated according to all listings or new listings and actual generation of the report is achieved responsive to actuations of a create report button 2204.

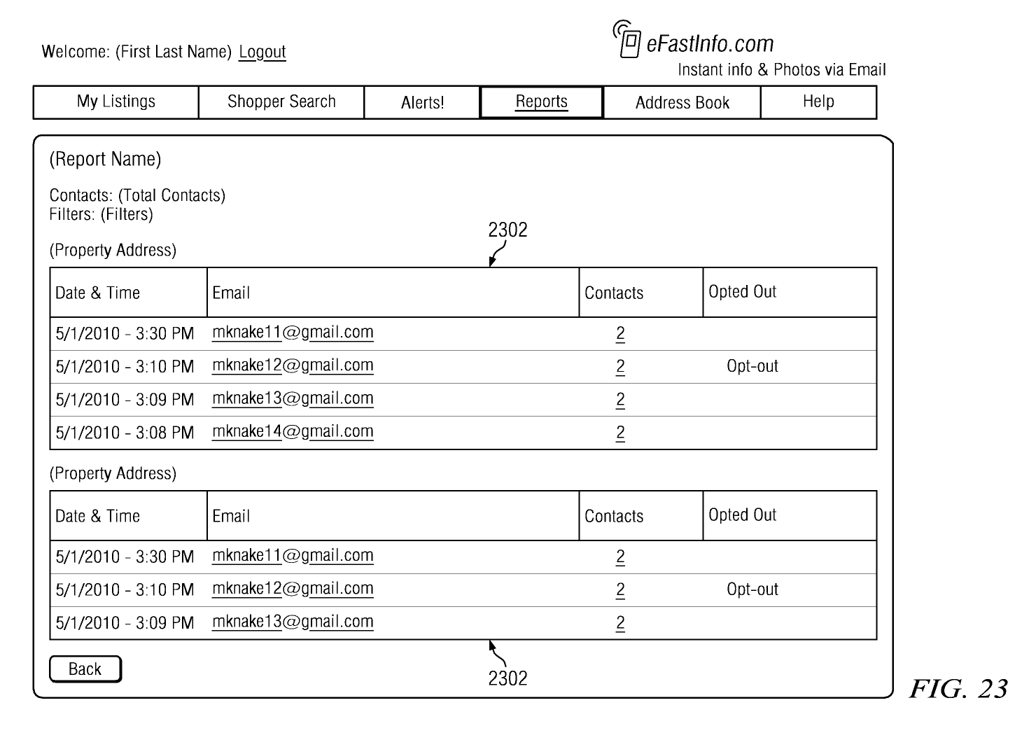

Once a report is created, it is provided in, for example, in the format illustrated in FIG. 23. The report of FIG. 23 includes a report separated into a number of property address windows 2302. Each of the property address windows includes a number of contacts therein with various information associated with each of the contacts.

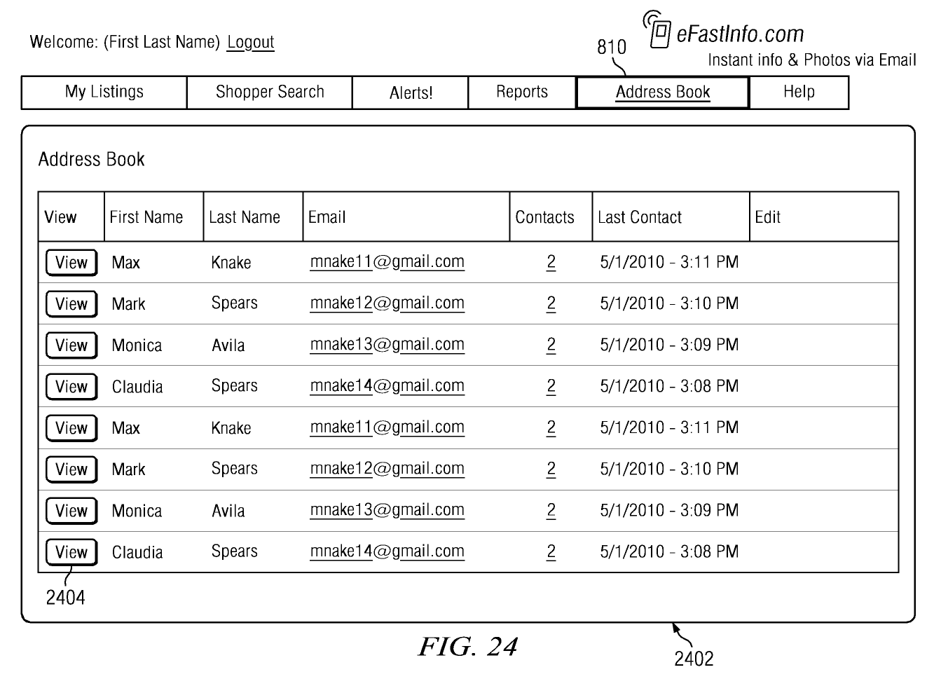

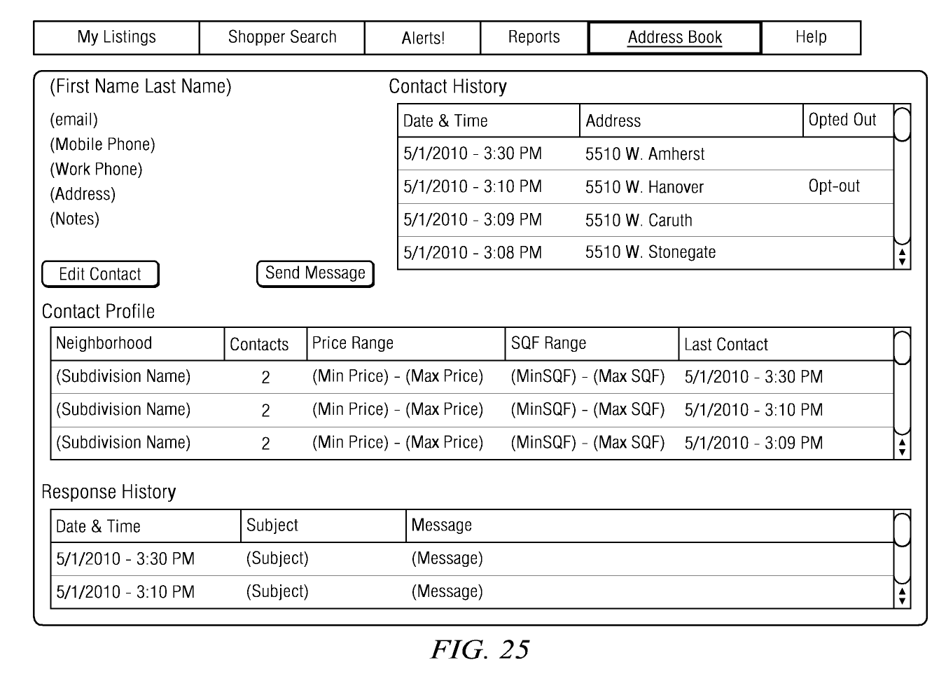

Referring now to FIG. 24, there is illustrated the address book interface 2402 that displays when the address book link 810 is initiated. The address book interface 2402 contains the names of contacts, their email addresses and various other contact parameters. A more particular listing with respect to the contact may be viewed by clicking on an associated view button 2404. By clicking on the view button 2404, the interface illustrated in FIG. 25 is displayed.

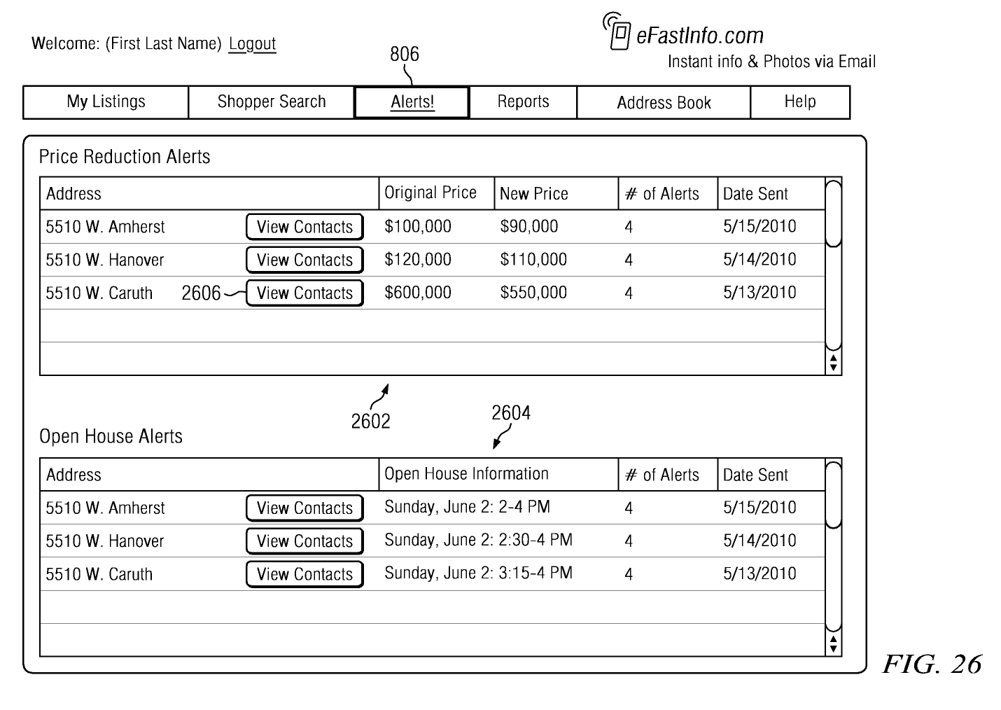

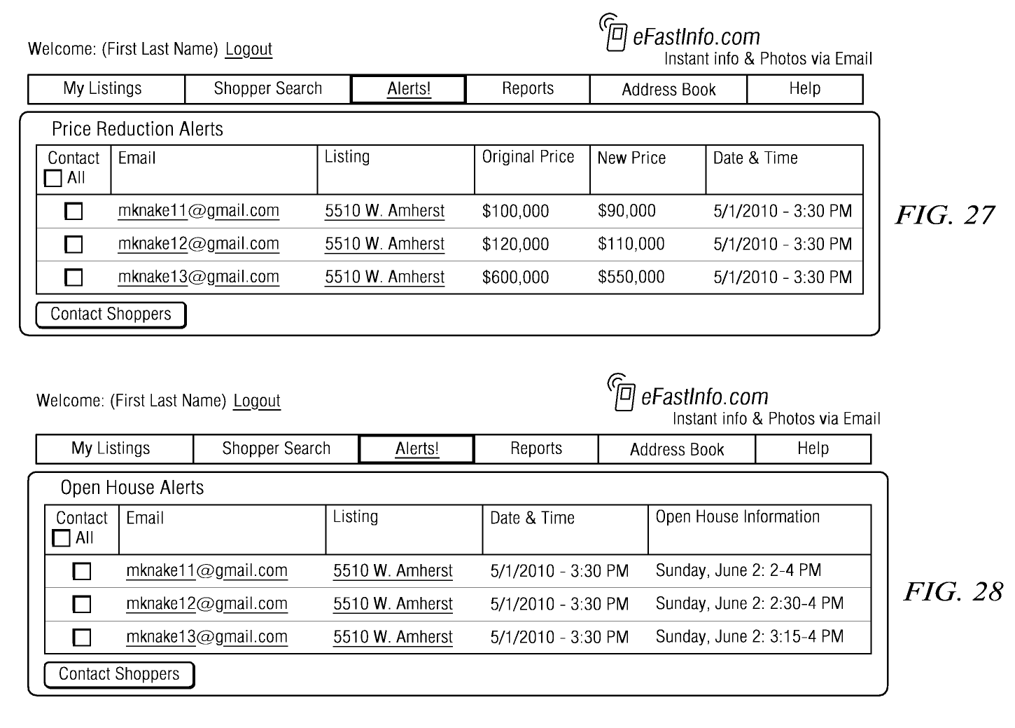

Referring now to FIG. 26, there is illustrated the alerts interface, which may be displayed to a subscriber. These are alerts generated responsive to changes in property data associated with a property. The alerts interface includes a price reduction alert window 2602 and an open house alert window 2604. Additional types of alerts may also be displayed as necessary. The price reduction alerts window 2602 displays information with respect to particular properties within the subscriber's portfolio that have had a price reduction posted with respect thereto. Similarly, the open house alerts window 2604 provides an indication of properties within the subscriber's portfolio that are going to have an open house. This is automatically generated information to the subscriber similar to that generated to the potential buyer as described with respect to FIG. 5. The subscriber accesses associated contacts with respect to the property for which the alert has been generated by clicking on the view contacts buttons 2606 associated with the property. By clicking on a view contacts button 2606 associated with the price reduction alert property, an interface such as that illustrated in FIG. 27 will be provided. Similarly, by clicking on a view contacts button associated with an open alerts property, the interface as illustrated in FIG. 28 will be provided.

Using the above-described system and method of operation, potential buyers of commercial or residential property may obtain up-to-date real time information with respect to properties they are interested in by emailing the contact code to a designated email address. Similarly, the agents that are selling these properties may have up-to-date real time information provided to them with respect to particular buyers that are interested in their properties by creating a database of contacts associated with the properties and have ways of easily managing their contacts and properties through an online interface.

It will be appreciated by those skilled in the art having the benefit of this disclosure that this system and method for providing real estate information to potential buyers provides an improved system and process for automatically providing real time property information to potential buyers while at the same time, enabling real estate brokers/agents to more efficiently manage their properties and potential contacts with respect thereto. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A system for providing real time property data to a potential real estate customer, comprising:
a property information server for providing the real time property data to the potential real estate customer responsive to a unique identifier associated with a particular property;
a database for storing the real time property data;
an email database for storing an email address associated with the potential real estate customer;
wherein the property information server initiates the generation and transmission of an email including the real time property data to the potential real estate customer responsive to receipt of an email from the potential real estate customer including the unique identifier associated with the particular property;
wherein the property information server stores the email address of the potential real estate customer indexed to the particular property associated with the unique identifier in the email database responsive to the receipt of the email from the potential real estate customer; and
wherein the property information server initiates the generation and transmission of an email to notify a subscriber of an interest in the particular property by the potential real estate customer responsive to the receipt of the email.

2. The system of claim 1, wherein the property information server associates an opt-out indication with the email address of the potential real estate customer responsive to a second email from the potential real estate customer including the unique identifier associated with the particular property and an opt-out indication.

3. The system of claim 1, wherein the property information server initiates the generation and transmission of update alert emails to the potential real estate customer responsive to changes in selected parameters of the real time property data.

4. The system of claim 1, wherein the unique identifier from the potential real estate customer is included within a subject line of the email.

5. The system of claim 1, wherein the property information server further includes a plurality of email templates for a generation of emails to the potential real estate purchaser and the subscriber.

6. The system of claim 1, wherein the property information server generates the unique identifier that is associated with the particular property by the subscriber during a subscriber registration process.

7. The system of claim 1, wherein the property information server provides a management function enabling a subscriber to enter the particular property and associate the unique identifier and the property data with the particular property.

8. The system of claim 1, wherein the property information server provides an email function enabling the subscriber to access the email address of the potential buyer through each of an address of the particular property or a contacts list.

9. The system of claim 1, wherein the property information server provides a search function for searching the email database for email addresses of potential buyers responsive to selected parameters relating to the property data associated with particular properties inquired about by the potential buyers.

10. The system of claim 1, wherein the property information server periodically updates the real time data with respect to the particular property on a periodic basis.

11. The system of claim 1 further including an email server for transmitting emails between the potential buyer and the property information server.

12. A method for providing real time property data to a potential real estate customer, comprising the steps of:
storing the real time property data in a property information server, the real time property data indexed to a particular property;
receiving an email from a potential customer relating to a particular property at the property information server, the email including a unique identifier associated with the particular property;
generating a property data email including the real time property data associated with the particular property to the potential real estate customer responsive to receipt of the email from the potential real estate customer including the unique identifier associated with the particular property;
transmitting the property data email to the potential real estate customer;
storing an email address associated with the potential real estate customer in an email database associated with the property information server responsive to the receipt of the email from the potential real estate customer;
generating a notification email to notify a subscriber of an interest in the particular property by the potential real estate customer responsive to the receipt of the email; and
transmitting the notification email to the subscriber.

13. The method of claim 12, wherein the step of generating a property data email further includes the steps of:
receiving a second email from the potential real estate customer including the unique identifier associated with the particular property and an opt-out indication;
associating an opt-out indication with the email address of the potential real estate customer responsive to the second email from the potential real estate customer.

14. The method of claim 12 further including the steps of:
detecting changes in selected parameters of the real time property data associated with the particular property;
generating an update alert email responsive to changes in the selected parameters of real time property data associated with the particular property; and
transmitting the update alert email to the potential real estate customer.

15. The method of claim 12, wherein the step of receiving the email from the potential real estate customer further includes the step of receiving the email with the unique identifier included within a subject line of the email.

16. The method of claim 12, wherein the step of generating the property data email further includes the step of generating the property data email using an email template from a plurality of email templates stored within the property information server.

17. The method of claim 12 further including the step of generating the unique identifier that is associated with the particular property by the subscriber during a subscriber registration process.

18. The method of claim 12 further including the steps of:
generating a subscriber interface including a plurality of data fields associated with property data for the particular property and the unique identifier associated with the particular property; and
receiving entries in the data fields of the subscriber interface from the subscriber.

19. The method of claim 12 further including the steps of generating a subscriber interface providing access to the email address of the potential buyer through either an address of the particular property or a contacts list.

20. The method of claim 12 further comprising the steps of:
receiving at least one parameter relating to the property data associated with particular properties at the property information server from a subscriber;
searching the email database for email addresses of potential buyers responsive to the received at least one parameters relating to the property data associated with particular properties;
generating a list of particular properties responsive to the search including at least one particular property including the at least one parameter relating to the property data; and
transmitting an email to the potential buyer including the list of particular properties.

21. The method of claim 12 further including the step of periodically updating the real time data with respect to the particular property.
